(19) United States
(12) Patent Application Publication
(10) Pub. No.: US 2022/0016591 A1
(43) Pub. Date: Jan. 20, 2022

(54) Hydrogen Generator

(71) Applicant: Nippon Telegraph and Telephone Corporation, Tokyo (JP)

(72) Inventors: Yosuke Takeuchi, Musashino-shi, Tokyo (JP); Masayuki Tsuda, Musashino-shi, Tokyo (JP); Yoko Ono, Musashino-shi, Tokyo (JP); Takuya Kamisho, Musashino-shi, Tokyo (JP)

(21) Appl. No.: 17/295,988

(22) PCT Filed: Nov. 12, 2019
(86) PCT No.: PCT/JP2019/044214

§ 371 Date: May 21, 2021

(30) Foreign Application Priority Data
Nov. 26, 2018 (JP) 2018-220219

(51) Int. Cl. B01J 16/00; B01J 19/00; C01B 3/08

(52) U.S. Cl. CPC B01J 16/00; C25D 11/00; C01B 3/08; B01J 19/00

(57) ABSTRACT

A hydrogen generation device capable of generating hydrogen using an inexpensive material is provided. The hydrogen generation device includes: a water flow path unit through which a solution flows in from outside and exits; a hydrogen generation unit made of a metal, the hydrogen generation unit generating hydrogen by a reaction with the flowing-in solution; and a hydrogen collection unit for collecting the generated hydrogen, wherein the hydrogen generation unit is disposed so that friction with the flowing-in solution peels off a surface film of the metal to expose an active surface of the metal, the metal being the hydrogen generation unit itself.

### TECHNICAL FIELD

The present invention relates to a technique of generating hydrogen as an energy source.

### BACKGROUND ART

A method for hydrogen generation relies on either electrolysis or a chemical reaction. In a method of electrolyzing water, a voltage is applied across electrodes disposed in water to generate hydrogen. Therefore, a material having high electrical stability and high corrosion resistance is used for the electrodes. For example, expensive materials such as Ni-based, conductive oxide, FeNi alloy-based, Ni-based, IrO₂-based, Pt-based, conductive oxide-based, and nickel/YSZ composites are used (Non-Patent Literature 1). On the other hand, examples of the chemical reaction method include a method using a reaction between iron and an acid and a method using a reaction between aluminum and calcium hydroxide.

### CITATION LIST

### Non-Patent Literature

Non-Patent Literature 1: Mitsushima, et al. “Present technologies and subjects of water electrolysis”, Suiso enerugi shisutemu (Hydrogen Energy System), Vol. 36, 2011, pp. 11-16
Non-Patent Literature 2: Miyasaka, et al., “Erosion-Corrosion of Fluid Machinery and Environmental Equipment”, Zairyo-to-Kankyo, Vol. 57, No. 3, 2008, pp. 111-117.
Non-Patent Literature 3: Nagumo, “Hydrogen Entry into Metals from Liquid Phase I”, Zairyo-to-Kankyo, Vol. 55, No. 9, 2006, pp. 380-389.

### SUMMARY OF THE INVENTION

### Technical Problem

In both electrolysis and chemical reaction methods, it is desirable to use inexpensive materials and safely generate hydrogen. However, in the method by electrolysis, an expensive material such as a noble metal or a conductive oxide is generally used as an electrode material. On the other hand, the methods by a chemical reaction can generate hydrogen with an inexpensive material, while some have high corrosiveness or others involve heat generation, thereby being highly dangerous.

The present invention has been made with respect to the above circumstances, and a first object thereof is to provide a hydrogen generation device capable of generating hydrogen using an inexpensive material and a second object thereof is to provide a hydrogen generation device capable of safely generating hydrogen.

### Means for Solving the Problem

A hydrogen generation device of the present invention includes: a water flow path unit through which a solution flows in from outside and exits, a hydrogen generation unit made of a metal; the hydrogen generation unit generating hydrogen by a reaction with the flowing-in solution; and a hydrogen collection unit for collecting the generated hydrogen, wherein the hydrogen generation unit is disposed so that friction with the flowing-in solution peels off a surface film of the metal to expose an active surface of the metal, the metal being the hydrogen generation unit itself.

In the above hydrogen generation device, the hydrogen generation unit is characterized in that it is disposed so that friction with the solution falling from a high place to a low place peels off a surface film of the metal to expose an active surface of the metal, the metal being the hydrogen generation unit itself.

In the above hydrogen generation device, the solution is characterized in that it is within an alkaline to neutral range or within the range of pH 7 to pH 14.

In the above hydrogen generation device, the hydrogen generation unit is characterized in that it is made of a metal that forms a surface film due to an electrochemical reaction in the solution.

In the above hydrogen generation device, the hydrogen generation unit is characterized in that it is made of any one of pure iron, carbon steel, an alloy or a pure metal containing Ni, Zn, Al, Cu, Mg, Ti, Mn, and Ag.

### Effects of the Invention

According to the present invention, it is possible to provide a hydrogen generation device capable of generating hydrogen using an inexpensive material. Further, it is possible to provide a hydrogen generation device capable of safely generating hydrogen.

### BRIEF DESCRIPTION OF DRAWINGS

FIG. 1 is a schematic diagram showing a side surface of a hydrogen generation device 1 according to a first embodiment.

FIG. 2 is a schematic diagram showing a side surface of a hydrogen generation device 1 according to a second embodiment.

FIG. 3 is a diagram showing measurement results of hydrogen.

### DESCRIPTION OF EMBODIMENTS

The present invention is characterized in that, with respect to hydrogen generation by chemical reaction, accelerating a reaction between a solution and a metal generates hydrogen in a safe system using a low-reactive solution within the range of alkaline (pH 14) to neutral (pH 7) in a following method. The following method is to peel off (wear off) the metal surface film by the frictional action of the flowing-in solution to expose an active surface.

For example, when iron (Fe) is used, the iron forms a surface film such as Fe(OH)₂, Fe(OH)₃ in an aqueous solution within an alkaline to neutral range, so that a reaction between Fe and H₂O does not occur and hydrogen is hardly generated. Therefore, in the present invention, in such a safe system, the Fe surface film is removed using a flow of H₂O, which newly exposes a Fe surface, and the newly exposed Fe surface reacts with H₂O to generate hydrogen.

To remove the metal surface film, the friction and wear actions of the solution and the metal is used. Specifically, the flow of the solution flowing in the horizontal direction or the drop of the solution falling in the vertical direction is used. The flow of the solution or the drop of the solution may be mechanically generated, or renewable energy, that is, the flow of a river, the flow of an ocean current, the waterfall water, the rainwater or the like may be used.

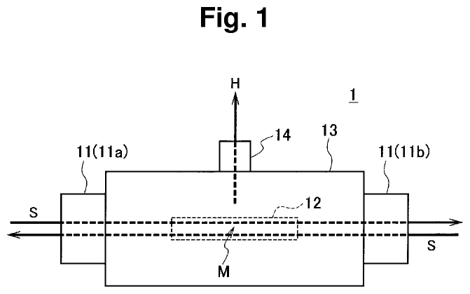

FIG. 1 is a schematic diagram showing a side surface of a hydrogen generation device 1 according to a first embodiment. The hydrogen generation device 1 utilizes the flow of a river or the flow of an ocean current that flows in a fixed horizontal direction to generate hydrogen. As shown in FIG. 1, the hydrogen generation device 1 mainly includes a water flow path unit 11, a hydrogen generation unit 12, a hydrogen collection unit 13, and a hydrogen discharge tube 14.

The water flow path unit 11 is a water flow path for a solution S flowing-in from the outside of the hydrogen generation device 1 and outflowing, and has a tubular shape and structure through which the solution S can flow in an exit. The water flow path unit 11 includes a first portion 11a and a second portion 11b, each of which is fixedly disposed on each of the opposite side surfaces of the hydrogen collection unit 13, which is the base of the hydrogen generation device 1. The positions of the first portion 11a and the second portion 11b are adjusted to be located on the same axis, so that the flow of the solution S flowing-in and outflowing through the hydrogen collection unit 13 is smooth, that is, the position does not affect the friction and wear actions of the solution S and the metal M (hydrogen generation unit 12).

The hydrogen generation unit 12 is a plate-shaped metal M that generates hydrogen by a reaction with the solution S flowing-in from the water flow path unit 11. The hydrogen generation unit is fixedly disposed inside the hydrogen collection unit 13 so that, inside the hydrogen collection unit 13, friction and wear with the solution S flowing-in from the water flow path unit 11 peels off the surface film of the metal M, which is the hydrogen generation unit 12 itself, to expose an active surface, thereby causing peeling of the surface film and exposure of an active surface. For example, as shown in FIG. 1, the hydrogen generation unit 12 is fixedly disposed to be located on the same axis as the water flow path unit 11, that is, on the water flow path of the solution S that linearly flows from the first portion 11a to the second portion 11b of the water flow path part 11 or in the opposite direction.

The hydrogen collection unit 13 is a housing for collecting the hydrogen generated by the hydrogen generation unit 12. The hydrogen collection unit 13 has a rectangular parallelepiped shape with a hollow inside, and has the hydrogen generation unit 12 (metal M) fixedly disposed therein. The hydrogen collection unit 13 has through holes formed on both side surfaces opposite with each other to connect to the first portion 11a and the second portion 11b of the water flow path unit 11, respectively, through each of which the solution S flows in and exits. Further, the hydrogen collection unit 13 has a through hole formed on the upper surface for releasing the hydrogen H generated in the hydrogen generation unit 12. Further, a hydrogen discharge tube 14 for releasing hydrogen to the outside is fixedly disposed at the position of the through hole on the upper surface.

The above is the configuration of the hydrogen generation device 1 according to the first embodiment. In the hydrogen generation device 1, the solution S used in this embodiment is a solution within the range of alkaline (pH 14) to neutral (pH 7). The solution S is less dangerous and relatively safer than an acid solution which is highly corrosive and involves heat generation. Therefore, hydrogen can be safely generated. Further, the metal M is a metal that produces a surface film in the solution S due to an electrochemical reaction. For example, the metal M is pure iron, carbon steel, an alloy or pure metal containing Ni, Zn, Al, Cu, Mg, Ti, Mn, and Ag.

When the hydrogen collection unit 13 of the hydrogen generation device 1 shown in FIG. 1 is submerged in a river having a flow velocity above a certain level, the water of the river (solution S) flows in from one side of water flow path unit 11 (the first portion 11a or the second portion 11b) and exits from the other side of water flow path unit 11 (the second portion 11b or the first portion 11a). At this time, the flowing-in water comes into contact with iron (metal M), which is the hydrogen generation unit 12 on the flowing water path, to generate friction. When the friction is continuously generated, the surface of iron is worn off, the surface film is peeled off, and an active surface is exposed, so that the newly exposed active surface of iron reacts with river water to generate hydrogen. The generated hydrogen collects inside the hollow of the hydrogen collection unit 13 and is released from the hydrogen discharge tube 14 to the outside of the hydrogen generation device 1.

When using the flow of the solution flowing in the horizontal direction, the flow velocity differs depending on the material of the hydrogen generation device 1 or the flowing water environment. Therefore, it is desirable to adjust the flow velocity of the solution S that flows to the hydrogen collection unit 13 to contact the hydrogen generation unit 12 (metal M) by a following method (Non-Patent Literature 2). The following method is a method of calculating, in advance, the required predetermined flow rate at which the friction and wear actions of the solution S and the metal M are generated, and giving a throttle for adjusting the flow velocity to the flowing water path structure of the water flow path unit 11, for example.

Further, the metal M of the hydrogen generation unit 12 may have any shape, but the shape is desirably a mesh shape, a porous shape, or a layered structure to increase the surface area in order to increase the amount of hydrogen generated. Further, the hydrogen generation unit 12 functions as a consumable part because it is worn off due to corrosion.

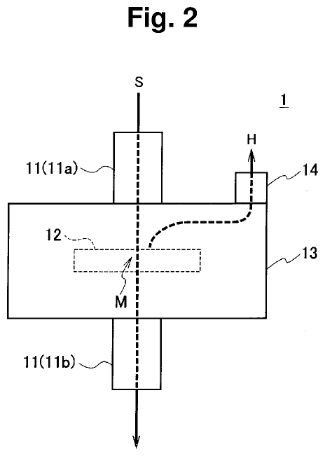

FIG. 2 is a schematic diagram showing a side surface of a hydrogen generation device 1 according to a second embodiment. The hydrogen generation device 1 utilizes the potential energy of waterfall water, rainwater, or the like falling from a high place to a low place to generate hydrogen. As shown in FIG. 2, the hydrogen generation device 1 also includes mainly a water flow path unit 11, a hydrogen generation unit 12, a hydrogen collection unit 13, and a hydrogen discharge tube 14. The hydrogen generation device 1 is different from the first embodiment in that a first portion 11a and a second portion 11b of the water flow path unit 11 are fixedly disposed on the upper and lower side surfaces of the hydrogen collection unit 13, respectively. The other configurations are the same as that of the first embodiment.

When the hydrogen generation device 1 shown in FIG. 2 is located inside a waterfall, the falling water (solution S) of the waterfall flows in from the upper water flow path unit 11 (a first portion 11a) and exits from the lower water flow path unit 11 (a second portion 11b). At this time, the flowing-in water comes into contact with iron (metal M), which is the hydrogen generation unit on the flowing water path, to generate friction. When the friction is continuously generated, the surface of iron is worn off, the surface film is peeled off, and an active surface is exposed, so that the newly exposed active surface of iron reacts with the waterfall water to generate hydrogen. The generated hydrogen collects inside the hollow of the hydrogen collection unit and is released from the hydrogen discharge tube 14 to the outside of the hydrogen generation device 1.

Here, in the second embodiment, water existing at a high position such as waterfall water or rainwater storage is used as the solution S, and its potential energy is converted into kinetic energy to be utilized. Therefore, it is desirable to estimate in advance the potential energy required for peeling off the surface film of the metal M and adjust the vertical length of the water flow path unit 11 or the amount of solution stored before flowing in.

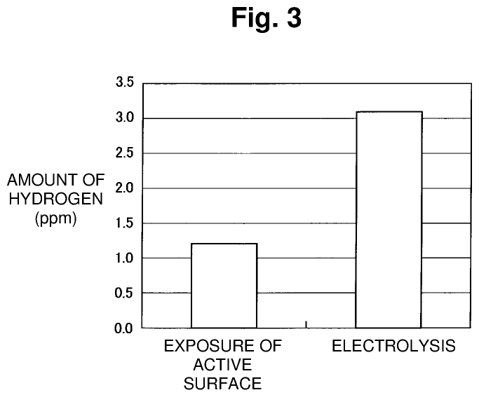

FIG. 3 is a diagram showing a measurement result in which hydrogen is generated by exposure of an active surface of iron. For comparison, a measurement results of the conventional electrolysis method are shown together. The measurement results shown in FIG. 3 are results obtained by measuring, with a thermal desorption analyzer, a portion of generated hydrogen that has penetrated into iron. The iron used for exposure of an active surface was in the shape of a disk having a diameter of 7 mm and a thickness of 1 mm, and the active surface was artificially exposed by performing mechanical wet polishing for about 10 minutes. Further, the iron provided for electrolysis had the same shape as the iron provided for exposure of an active surface, and hydrogen was generated for 12 hours by applying a voltage of −1 V based on the silver-silver chloride electrode.

The measurement results shown in FIG. 3 are results of measurements of a portion of generated hydrogen that has penetrated into iron. The electrolysis had about 3 ppm of hydrogen detected, while the exposure of an active surface had about 1 ppm of hydrogen detected. From this, it was shown that the exposure of an active surface generated hydrogen of the same order, though not as much as electrolysis generated. This result shows that hydrogen is generated in a short time by performing mechanical wet polishing to expose the active surface. However, it is theoretically clear that a similar amount of hydrogen is also generated in a case where a water stream is used under a condition where an active surface is exposed. Note that the hydrogen that penetrates into the iron is an extremely small portion of the hydrogen adsorbed on the metal surface (Non-Patent Literature 3).

This embodiment includes: a water flow path unit 11 through which a solution S flows in from outside and exits; a hydrogen generation unit 12 made of a metal M; the hydrogen generation unit 12 generating hydrogen H by a reaction with the flowing-in solution S; and a hydrogen collection unit 13 for collecting the generated hydrogen H. And the hydrogen generation unit 12 is disposed so that friction with the flowing-in solution S peels off a surface film of the metal M, which is the unit itself, to expose an active surface of the metal. That is, in this embodiment, since the wear caused by flow of the solution is used for exposure of an active surface of the metal M for generating hydrogen H, it is possible to provide a hydrogen generation device capable of generating hydrogen using an inexpensive material.

Further, according to this embodiment, since the solution S within the range of alkaline (pH 14) to neutral (pH 7) is used, it is possible to provide a hydrogen generation device capable of safely generating hydrogen.

In summary, in this embodiment, under conditions where the reaction of metal and water is inhibited due to formation of a surface film in an alkaline to neutral solution, the friction and wear actions intermittently peel off the film and expose an active surface to accelerate hydrogen generation due to the chemical reaction of metal and water. This makes it possible to generate hydrogen in a safe reaction system using an inexpensive material. For example, renewable energy can be used to achieve hydrogen generation.

### REFERENCE SIGNS LIST

1 hydrogen generation device
11 water flow path unit
11a first portion
11b second portion
12 hydrogen generation unit
13 hydrogen collection unit
14 hydrogen discharge tube

1. A hydrogen generation device, comprising:
a water flow path unit through which a solution flows in from outside and exits;
a hydrogen generation unit made of a metal, the hydrogen generation unit generating hydrogen by a reaction with the flowing-in solution; and
a hydrogen collection unit for collecting the generated hydrogen,
wherein the hydrogen generation unit is disposed so that friction with the flowing-in solution peels off a surface film of the metal to expose an active surface of the metal, the metal being the hydrogen generation unit itself.

2. The hydrogen generation device according to claim 1, wherein the hydrogen generation unit is disposed so that friction with the solution falling from a high place to a low place peels off a surface film of the metal to expose an active surface of the metal, the metal being the hydrogen generation unit itself.

3. The hydrogen generation device according to claim 1, wherein the solution is within an alkaline to neutral range or within the range of pH 7 to pH 14.

4. The hydrogen generation device according to claim 3, wherein the hydrogen generation unit is made of a metal that forms a surface film due to an electrochemical reaction in the solution.

5. The hydrogen generation device according to claim 4, wherein the hydrogen generation unit is made of any one of pure iron, carbon steel, and an alloy or a pure metal containing Ni, Zn, Al, Cu, Mg, Ti, Mn, and Ag.

6. The hydrogen generation device according to claim 2, wherein the solution is within an alkaline to neutral range or within the range of pH 7 to pH 14.
